(19) United States
(12) Patent Application Publication
(10) Pub. No.: US 2017/0002787 A1
(43) Pub. Date: Jan. 5, 2017

(54) DETECTION DEVICE FOR VEHICLE IGNITION SYSTEM

(71) Applicant: CHUNG-YI HUANG, Tw (TW)

(72) Inventor: CHUNG-YI HUANG, Tw (TW)

(21) Appl. No.: 15/165,989

(22) Filed: May 26, 2016

(30) Foreign Application Priority Data
Jun. 30, 2015 (TW) 104210533

(51) Int. Cl. F02P 17/12; G01M 15/04

(52) U.S. Cl. CPC F02P 17/12; G01M 15/042

(57) ABSTRACT

A detection device for vehicle ignition system includes a body with a first IC circuit board received therein which is electrically connected with a power source. A probe connected to the body and is electrically connected to a ground line and the first IC circuit board. The body has a connection hole, a power switch for activating the detection device, an activation switch, a first display unit and a second display unit. The ground line is connected with a metal part of a vehicle to form a loop. When the probe contacts the coil, the ignition voltage signal of the coil is detected and displayed on the first display unit, and the combustion time signal of the coil is detected and displayed on the second unit. By the two signals, the maintainers are acknowledged the operation condition of the ignition system of the vehicle.

### BACKGROUND OF THE INVENTION

1. Fields of the invention

The present invention relates to a detection device for detecting the ignition voltage signal and combustion time of the engine of a vehicle.

2. Descriptions of Related Art

The conventional control device for a vehicle ignition system generally comprises a battery, a main switch electrically connected to the battery, a coil electrically connected to the main switch, a spark plug electrically connected to the coil, and a detection member which detects the revolutions of the engine and generates corresponding signals to the revolutions of the engine. By using the detection member, the ignition time of the coil is controlled so as to activate the spark plug to generate sparks in the engine to ignite the fuel to move the vehicle.

The number of the vehicle engine includes even-number cylinders or odd-number cylinders, and the engine may be in condition of start-able or non-start-able. The prevent invention is able to choose the best way to detect the ignition system of the vehicle engine according to different types of the engines.

### SUMMARY OF THE INVENTION

The present invention relates to a detection device for a vehicle ignition system, and comprises a body, a ground line and a probe. The body has a first IC circuit board received therein which is electrically connected with a power source. The probe is electrically connected to the ground line and the first IC circuit board. The body has a connection hole, a power switch for activating the detection device, an activation switch, a first display unit and a second display unit. The ground line is connected with a metal part of a vehicle to form a loop. When the probe contacts the coil, the ignition voltage signal of the coil is detected and displayed on the first display unit, and the combustion time signal of the coil is detected and displayed on the second unit.

Preferably, the detection device has a diagnostic unit which has a second circuit board. The diagnostic unit further has a power switch electrically connected to the first IC circuit board, a display screen and a first I/O connection port on the outside thereof. A first connection cable unit has a first end and a second end, wherein the first end is inserted into the connection hole, and the second end is inserted into the first I/O connection port to detect the ignition voltage signal and the combustion time signal of the coil. The ignition voltage signal and the combustion time signal of the coil are sent to the diagnostic unit and displayed on the display screen. The probe and the ground line respectively perform as the positive end and the negative end to detect the voltage, the resistance and the current of a specific part of the vehicle.

The primary object of the present invention is to provide a detection device for a vehicle ignition system, and is able to detect the ignition system of the vehicle according to the number of cylinders, and the start-able status and non-start-able status of the engine.

Another object of the present invention is to provide a detection device for vehicle ignition system, wherein the detection device can be used as a multi-meter.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the detection device of the present invention;

FIG. 2 shows the side view of the body of the detection device of the present invention;

FIG. 3 shows the end view of the body of the detection device of the present invention;

FIG. 4 is a side view of the diagnostic unit of the detection device of the present invention;

FIG. 5 is an end view of the diagnostic unit of the detection device of the present invention;

FIG. 6 shows that the diagnostic unit is cooperated with the detection device of the present invention;

FIG. 7 shows the single cylinder engine to be detected;

FIGS. 7A and 7B show the detected signals of the ignition system of the single cylinder engine;

FIG. 8 shows the twin-cylinder engine to be detected, and

FIGS. 8A and 8B show the detected signals of the ignition system of the twin-cylinder engine.

### DETAILED DESCRIPTION OF THE PREFERRED EMBODIMENT

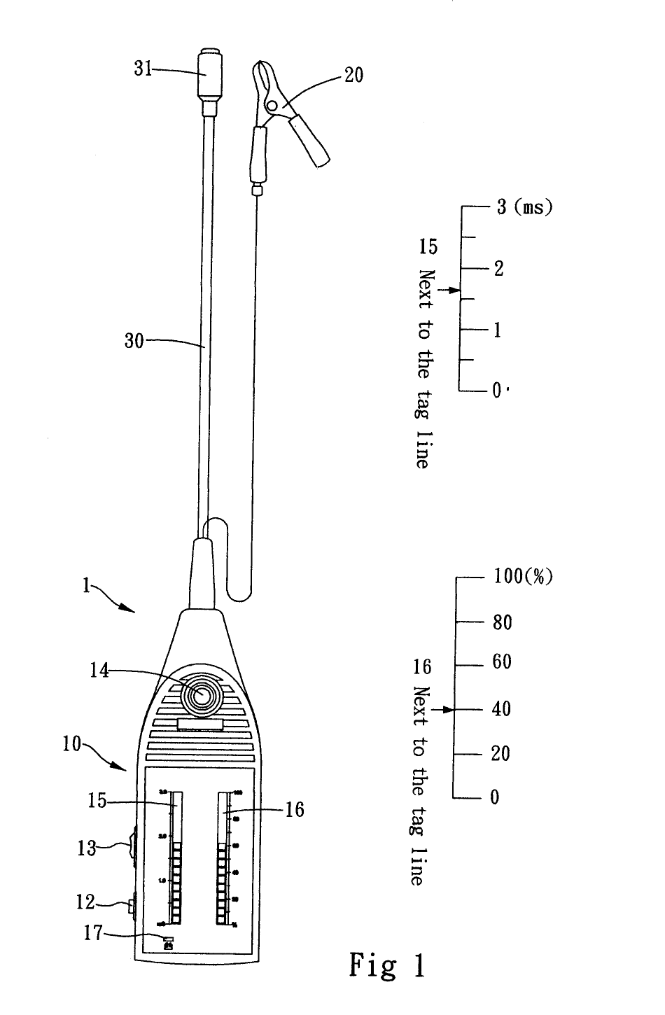

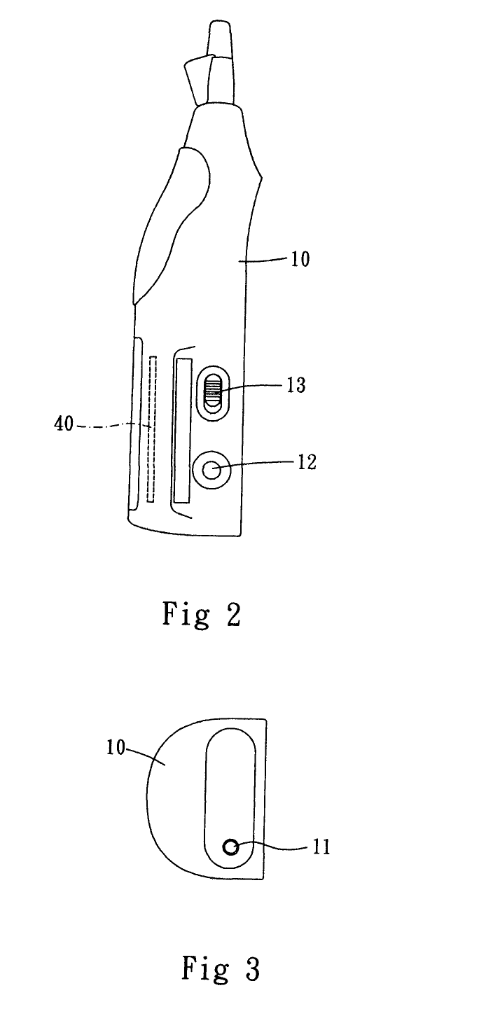

Referring to FIGS. 1 to 3, the detection device 1 of the present invention comprises a body 10, a ground line 20 and a probe 30, wherein the body 10 has a first IC circuit board 40 received therein which is electrically connected with a power source 50. In this embodiment, the power source 50 is a one-time-use battery or a two-time-use battery. The probe 30 is electrically connected to the ground line 20 and the first IC circuit board 40. The body 10 has a connection hole 11, a power switch 12 for activating the detection device 1, a mode selection portion 13, an activation switch 14, a first display unit 15, a second display unit 16 and a power source indication light 17.

The mode selection portion 13 can be shifted left and right to activate a first mode which is the cranking mode, and a second mode which is the running mode. When the vehicle cannot be started (the non-start-able status), the first mode is chosen. On the contrary, when the vehicle can be started (start-able status), the second mode is chosen. When the first or second mode is chosen, the activation switch 14 is operated to proceed the detection steps. The first and second display units 15, 16 are two Liquid Crystal Display (LCD) screens. The power source indication light 17 is electrically connected to the power source 50 to show the low battery when flashing, and to show the power source is dead when the power source indication light 17 is not in operation.

The ground line 20 is connected with a metal part of the vehicle to form a loop. The probe 30 retractably extends from the body 10 and has a head 31 at its distal end thereof. The head 31 can be in contact with the coil, and the activation switch 14 is operated to test which coil is not in service. The ignition voltage signal of the coil is detected and displayed on the first display unit 15, and the combustion time signal of the coil 70 is detected and displayed on the second unit 16. It is noted that the display of the two signals mentioned above is shown by the boxes, the more number of the boxes is shown, the voltage is higher and the combustion time is longer. Preferably, each of the first and second display units 15, 16 includes marks on one side thereof, such as the marks beside the first display unit 15 shows the percentage, and the marks beside the second display unit 16 shows the seconds. By this marks, the maintainers know the precise operation status of the operation of the engine.

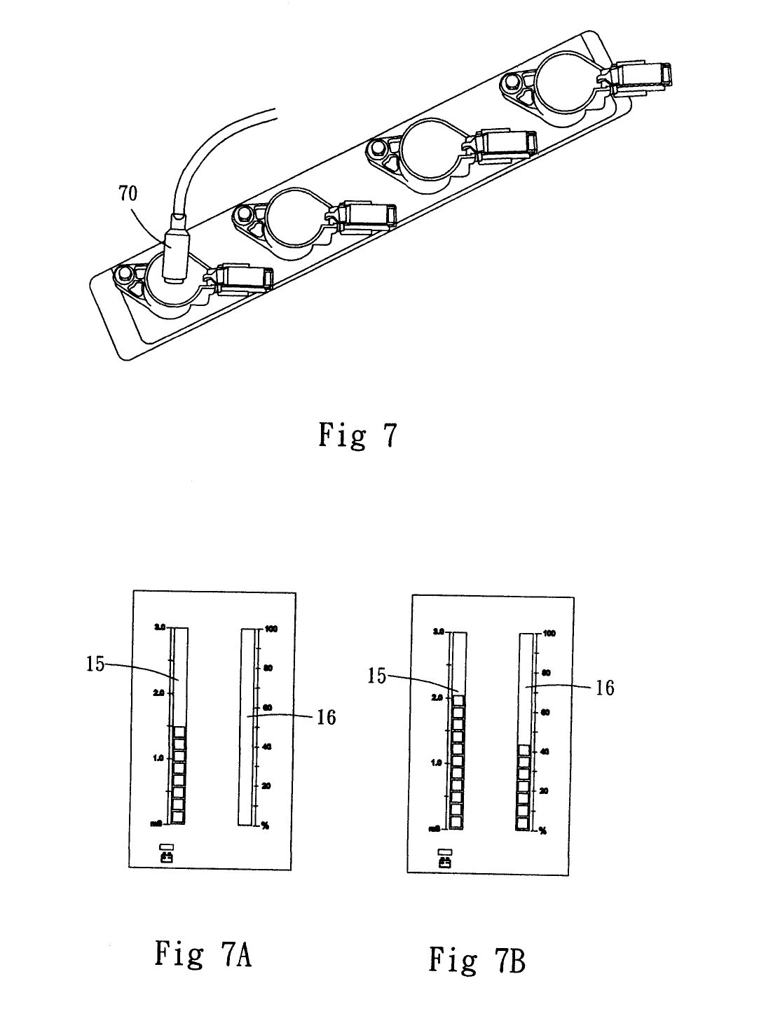

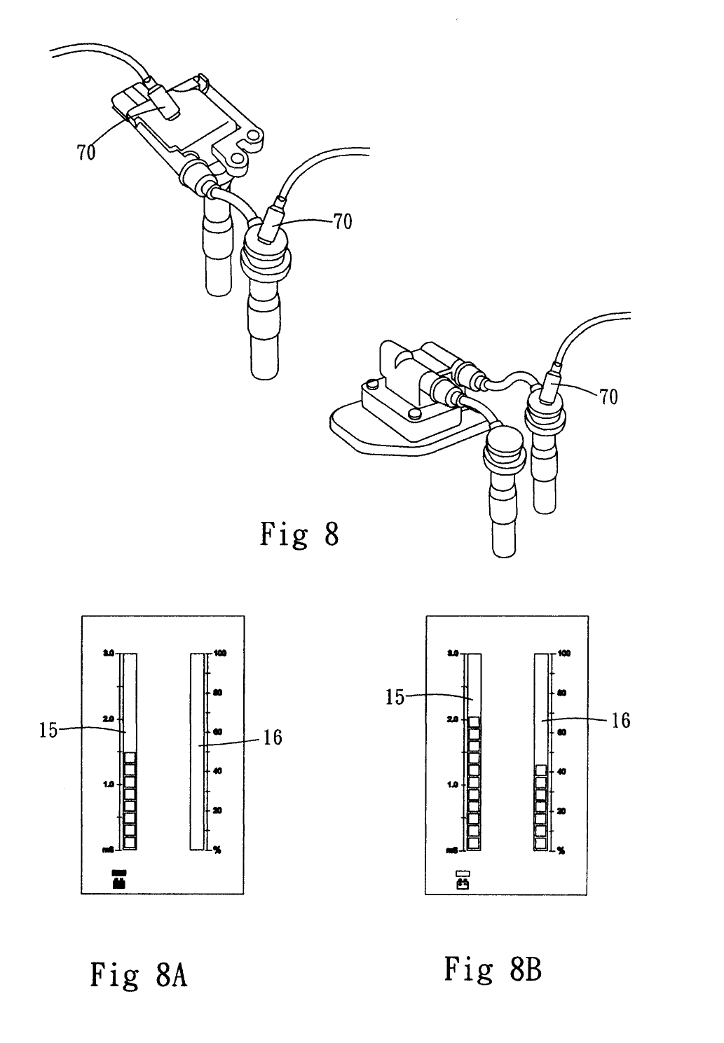

As shown in FIGS. 7, 7A, 7B, 8, 8A and 8B, when in use, the maintainers should check the engine is under the non-start-able status or the start-able status, if the engine is under the non-start-able status, the mode selection portion 13 is operated to the first mode (the cranking mode), and if the engine is under the start-able status, the mode selection portion 13 is operated to the second mode (the running mode). Then checking the engine is a single-cylinder engine or a twin-cylinder engine. If the engine is a single-cylinder engine, then FIGS. 7, 7A and 7B show the detection method. If the engine is a twin-cylinder engine, then FIGS. 8, 8A and 8B show the detection method.

When the engine is a single-cylinder engine which is under the non-start-able status, the first mode (the cranking mode) is chosen, and the head 31 contacts the coil 70, the activation switch 14 is operated to check the ignition voltage signal which is sent to the first display unit 15. The combustion signal cannot be detected because the engine cannot be started. By this way, each of the coils 70 can be checked.

When the engine is a single-cylinder engine which is under the start-able status, the second mode (the running mode) is chosen, and the head 31 contacts the coil 70, the activation switch 14 is operated to check the ignition voltage signal which is sent to the first display unit 15, and the combustion signal is detected and sent to the second display unit 16. By this way, each of the coils 70 can be checked. The questionable coil 70 can be found by the ignition voltage signal, and the spark plug can be checked by the detected combustion time.

When the engine is a twin-cylinder engine which is under the non-start-able status, the first mode (the cranking mode) is chosen, and the head 31 contacts one of the coils 70 of the twin-cylinder engine, the activation switch 14 is operated to check the ignition voltage signal which is sent to the first display unit 15. The steps can be repeated to check the other coil 70 of the twin-cylinder engine. The coils 70 of the twin-cylinder engine should be located at the same position for convenience of detection. The combustion signal cannot be detected because the engine cannot be started. By this way, each of the coils 70 can be checked.

When the engine is a twin-cylinder engine which is under the start-able status, the second mode (the running mode) is chosen, and the head 31 contacts one of the coils 70 of the twin-cylinder engine, the activation switch 14 is operated to check the ignition voltage signal which is sent to the first display unit 15. The steps can be repeated to check the other coil 70 of the twin-cylinder engine. The combustion signal of each cylinder is detected and sent to the second display unit 16. The coils 70 of the twin-cylinder engine should be located at the same position for convenience of detection.

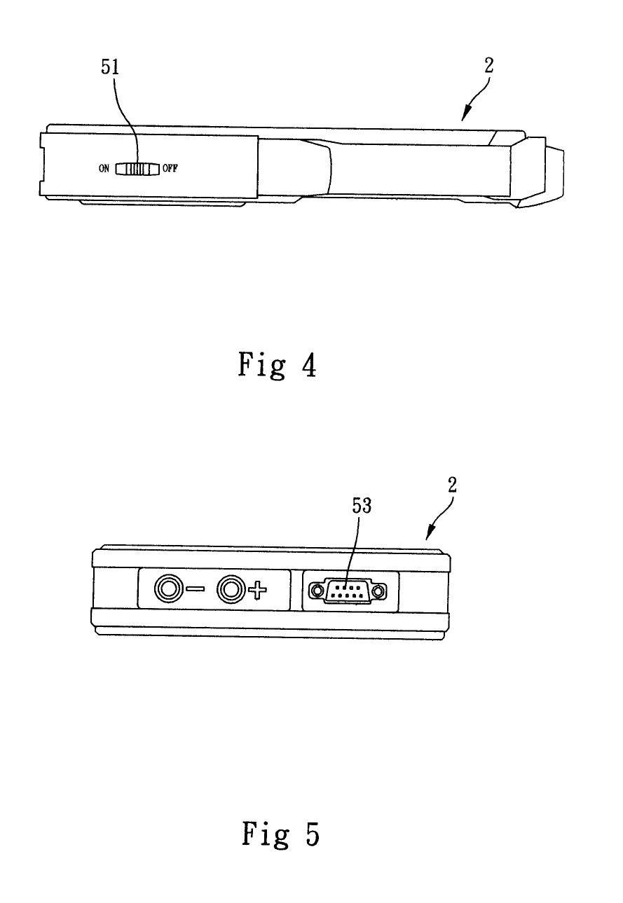

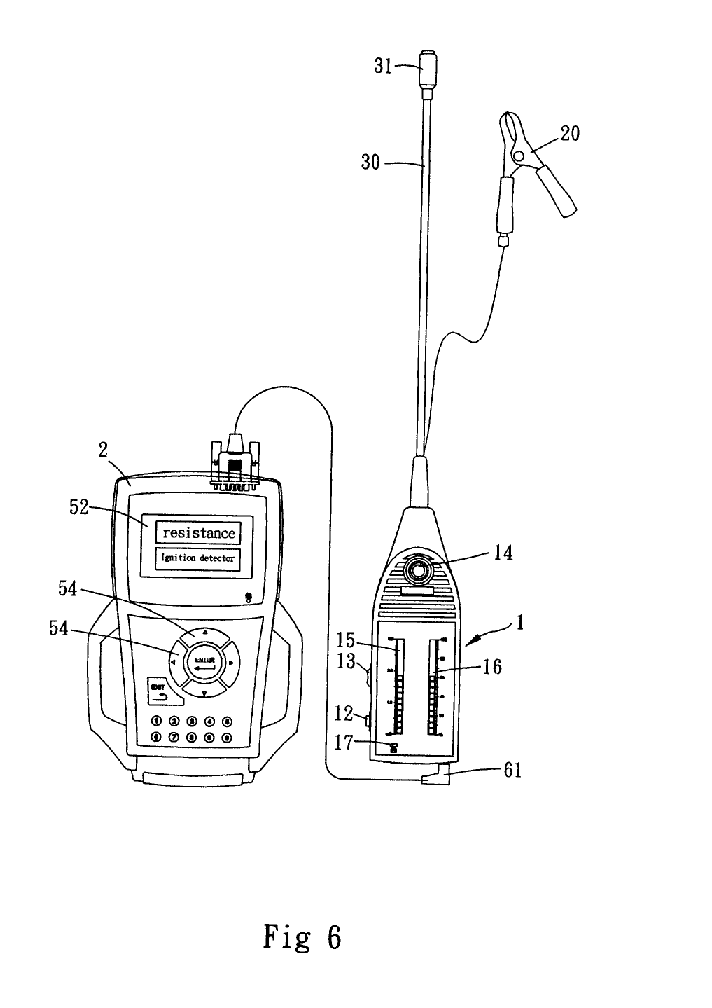

As shown in FIGS. 4 to 6, diagnostic unit 2 is cooperated with the detection device 1 and the diagnostic unit 2 has a second IC circuit board (not shown). The diagnostic unit 2 has a power switch 51 electrically connected to the first IC circuit board 40, a display screen 52 and a first I/O connection port 53 on the outside thereof. A first connection cable unit 60 has a first end 61 and a second end 62, wherein the first end 61 is inserted into the connection hole 11, and the second end 62 is inserted into the first I/O connection port 53 to connect the detection device 1 and the diagnostic unit 2. The detected ignition voltage signal and the combustion time signal of the coil 70 can be sent to the diagnostic unit 2 and displayed on the display screen 52 which is a Liquid Crystal Display screen. The ignition signal is shown in the form of waves. The diagnostic unit 2 has a function selection portion 54 formed on the outside thereof. When the head 31 of the probe 30 and the ground line 20 are respectively connected to the positive end and the negative end of the part to be checked, the detection device 1 can be used as a multi-meter to detect the voltage, the resistance and the current by operating the function selection portion 54.

The maintainers can quickly know the conditions of the engine by operation of the two statues mentioned above, and the engine can be a single-cylinder engine or a twin-cylinder engine. By judging the ignition voltage single and the combustion time signal, the maintainers know the situation or status of the ignition system. The detection device 1 can be cooperated with a diagnostic unit 2 to show the voltage single and the combustion time signal in the form of waves so that the maintainers can be acknowledged the coil 70 of which cylinder needs to be replaced or maintained. The detection device 1 can also be used as a multi-meter to get the information of the voltage, the resistance and the current of a specific part.

While we have shown and described the embodiment in accordance with the present invention, it should be clear to those skilled in the art that further embodiments may be made without departing from the scope of the present invention.

What is claimed is:

1. A detection device for vehicle ignition system, comprising:
a body, a ground line and a probe, the body having a first IC circuit board received therein which is electrically connected with a power source, the probe electrically connected to the ground line and the first IC circuit board, the body having a connection hole, a power switch for activating the detection device, an activation switch, a first display unit and a second display unit, the ground line adapted to be connected with a metal part of a vehicle, when the probe contacts the coil, an ignition voltage signal of the coil is detected and displayed on the first display unit, a combustion time signal of the coil is detected and displayed on the second unit.

2. The detection device as claimed in claim 1, wherein the body has a mode selection portion which provides an option of start-able and an option of non-start-able.

3. The detection device as claimed in claim 1, wherein the body has a power source indication light, the power source is installed in the body and is a one-time-use battery or a two-time-use battery.

4. The detection device as claimed in claim 3 further comprising a diagnostic unit which has a second IC circuit board, the diagnostic unit having a power switch electrically connected to the first IC circuit board, a display screen and a first I/O connection port on an outside thereof, a first connection cable unit having a first end and a second end, the first end inserted into the connection hole, the second end inserted into the first I/O connection port to detect the ignition voltage signal and the combustion time signal of the coil, the ignition voltage signal and the combustion time signal of the coil being sent to the diagnostic unit and displayed on the display screen.

5. The detection device as claimed in claim 4, wherein the diagnostic unit has a function selection portion formed on the outside thereof.
